(19) United States
(12) Patent Application Publication
(10) Pub. No.: US 2015/0269692 A1
(43) Pub. Date: Sep. 24, 2015

(54) Electronic Contract Creator

(71) Applicant: Jed Ryan, Erdenheim, PA (US)

(72) Inventor: Jed Ryan, Erdenheim, PA (US)

(21) Appl. No.: 14/658,146

(22) Filed: Mar. 14, 2015

Related U.S. Application Data
(60) Provisional application No. 61/955,040, filed on Mar. 18, 2014.

(51) Int. Cl. G06Q 50/18; G06Q 10/00

(52) U.S. Cl. CPC G06Q 50/18; G06Q 10/00

(57) ABSTRACT

An electronic device creates a contract between two parties and includes an identity determiner that determines and verifies, based on an analysis of a photograph or biometric data of a party to the contract, personal information about the party. A contract creator creates the contract between the parties, and a wireless transmitter transmits the contract over a network to secure storage after the contract receives consent from both parties.

### BACKGROUND

Creating a contract can be a laborious and time-consuming process. This process can be expensive and often requires a notary and an attorney or other person specializing in contract law. As such, people often forego using contracts.

Advancements in contract creation will assist parties in creating and using contracts.

### BRIEF DESCRIPTION OF THE DRAWINGS

FIG. 1 is a method to create a contract between two parties in accordance with an example embodiment.

FIG. 2 is a method to provide a recommendation and/or a warning to a person before the person enters into a contract with another person in accordance with an example embodiment.

FIG. 3 is a method to recommend a contract to a person based on one or more factors in accordance with an example embodiment.

FIG. 4 is a method to securely exchange a contract between two or more electronic devices in accordance with an example embodiment.

FIG. 5 is a computer system in accordance with an example embodiment.

FIGS. 6A-6D show electronic devices communicating with each other to create, exchange, and store a contract in accordance with an example embodiment.

FIG. 7 is an electronic device in accordance with an example embodiment.

FIG. 8 is another electronic device in accordance with an example embodiment.

### SUMMARY OF THE INVENTION

Example embodiments include systems, apparatus, and methods that create contracts.

An example electronic device includes an identity determiner that is stored in memory and that determines and/or verifies, based on an analysis of a photograph or biometric data of a party to a contract, personal information about the party. A contract creator generates or creates the contract between the parties. A wireless transmitter wirelessly transmits the contract over a network (such as a cellular network or the Internet) to secure storage after the contract receives consent from both parties.

Other example embodiments are discussed herein.

### DETAILED DESCRIPTION

Example embodiments include systems, apparatus, and methods that create, exchange, and store contracts for parties to a contract.

An example embodiment enables two individuals to create, capture, and store written contracts or agreements in real-time on the spot. For instance, an example embodiment replaces a traditional method of writing and negotiating terms of a contract, printing the contract on paper, signing a paper version of the contract, and storing physical copies of the signed contract.

An example embodiment also alleviates a need for a third party witness or notary to the contract since the example embodiment authenticates and/or verifies identities of the parties to a contract and their consent to the contract. Furthermore, an example embodiment alleviates a need for an attorney since contracts are pre-written or created in accordance with applicable state and federal laws.

An example embodiment identifies parties to a contract and verifies their identity using, for example, biometric data. Based on this identity and verification, the example embodiment retrieves and/or creates a contract with terms and conditions that cover needs and desires of the parties. Once the parties consent to the contract, the example embodiment validates and/or verifies that the contract is legally created and formed. By way of example, this validation and/or verification includes ensuring the legal sufficiency, existence, or non-existence of consent, identification of the parties, capacity, mistake, duress, undue influence, misrepresentation, frustration of purpose, and terms and conditions applicable for the purpose of the contract and governing law. For instance, a contract verifier verifies one or more of the following elements to a contract: offer that details what will be provided, acceptance by another party to the offer, consideration or something of value or interest being exchanged, capacity of the parties to enter into the contract (such as having a legal age and mental ability), intent of both parties to carry out the promises, and an object of the contract as being legal and not against public policy or violation of a law.

After the contract is created and signed, it is securely stored for subsequent retrieval.

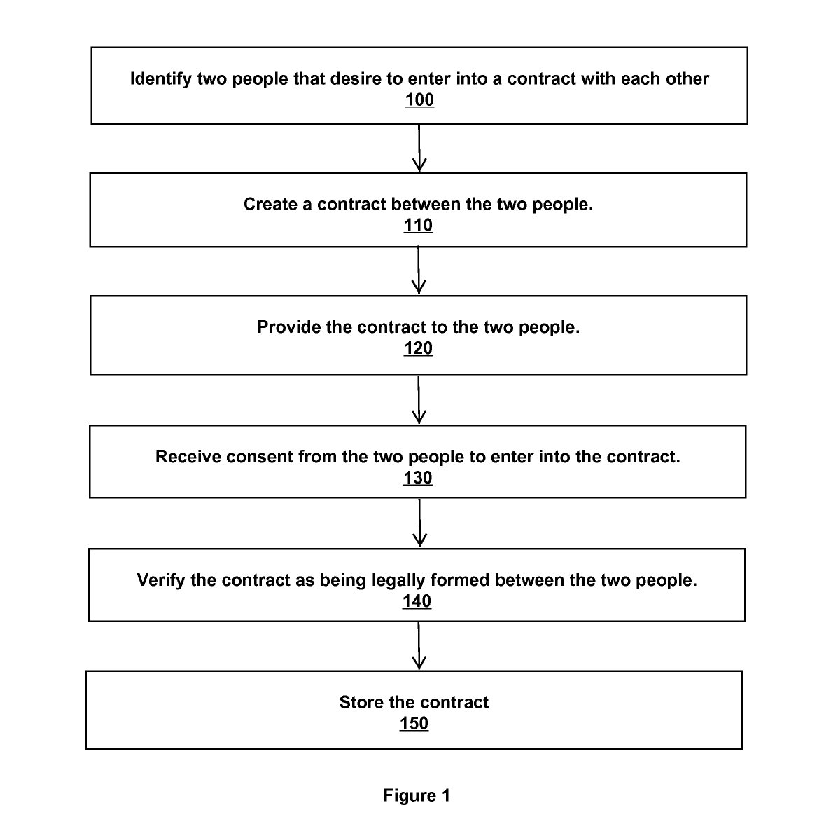

FIG. 1 is a method to create a contract between two parties.

Block 100 states identify two people that desire to enter into a contract with each other.

An example embodiment identifies a person using one or more of obtaining, capturing, receiving, or retrieving information about and/or from the person, determining an identity of the person (such as determining a name, an address, an age, and/or other personal information about the person), authenticating the person and/or information about the person (such as proving that something is real, true, or genuine), validating the person and/or information about the person (such as confirming, supporting, or corroborating the person and/or information about the person), recognizing the person, and processing information about the person.

Consider an example in which an electronic device obtains, captures, receives, or retrieves identifying information about the person. For example, the electronic device implements, utilizes, or executes one or more of biometric data recognition (such as capturing a physiological characteristic of the person including, but not limited to, a fingerprint, an audio or voice, a thumbprint, a palm print, facial recognition, a hand geometry, iris recognition, retina recognition, and Deoxyribonucleic Acid (DNA) recognition), behavioral or behaviometrics characteristic recognition (such as recognizing a pattern of a behavior of the person, a typing rhythm of the person, a data entry habit of the person), token-based identification system or recognition (such as a security token, digital signature, or cryptographic key), a knowledge-based identification system or recognition (such as a username, password, and/or personal identification number).

Block 110 states create a contract between the two people.

An example embodiment creates the contract between the two people. By way of example, this process includes one or more of generating, obtaining, retrieving, receiving, drafting, modifying, changing, editing, and completing a contract.

Consider an example in which an electronic device captures or obtains information about a person and provides this information into a contract. For instance, this information includes, but is not limited to, a name of the person, an age of the person, an address of the person, a location of the person (such as a Global Positioning System (GPS) or geographical location), a picture of the person, video of the person, terms and/or conditions of the contract, account information of the person, and other information discussed herein.

Consider another example in which an electronic device retrieves a contract template (such as a pre-formatted and/or pre-configured contract). The electronic device provides personal information into blanks or missing portions of the template to complete the contract.

Block 120 states provide the contract to the two people.

An example embodiment provides the contract to the two people. For example, an electronic device displays the contract, presents the contract, transmits the contract to another electronic device (such as emailing the contract to a person or transmitting it directly or indirectly to another electronic device), or reads the contract (such as executing a text to speech program that converts the text of the contract to natural speech).

Block 130 states receive consent from the two people to enter into the contract.

The two people agree to enter into the contract and express this agreement with an action. Examples of such an action include, but are not limited to, signing the contract (such as with a hand-written signature, an electronic signature, or a digital signature), expressing verbal consent (such as stating an agreement or acknowledgment to enter into the contract), providing biometric data (such as giving a thumbprint), checking a box in the contract (such as a box indicating acceptance of the contract), providing a gesture (such as capturing video of a person nodding, agreeing, or stating an agreement to enter into the contract), or taking another action with respect to the contract to indicate a willingness, consent, or desire to enter into the contract.

Block 140 states verify the contract as being legally formed between the two people.

An example embodiment verifies that the contract is a voluntary, deliberate, and legally binding agreement between two competent people evidenced with an offer, acceptance of the offer, and legal and valuable consideration. For example, an electronic device determines or verifies that the legal elements of the contract include one or more of mutual assent (such as willful offer and acceptance), intention to be legally bound, consideration (such as something bargained for and received by the two persons), capacity (such as soundness of mind and age capacity), and legality (lawfulness of the contract).

Verification of the contract can also include verifying person information about the parties to the contract. For example, an example embodiment verifies a full name and a current home address or business address of each party to the contract. In Western culture, a full name of an individual includes a given name (also known as a first name) and a surname (also known as a family name or last name). A full name of a person legally identifies the person and includes the given name and the surname.

Consider an example in which an example embodiment captures an image of a person and provides this image to a facial recognition system that identifies or verifies a full name of the person. For instance, the facial recognition system compares the captured image or selected facial features from the captured image to a database of facial images to determine whether a match exists with a known person.

Offer and acceptance occurs when the parties have mutual assent or a meeting of the minds. For example, when the parties consent verbally, with writing, or with a gesture. For instance, a natural language user interface interprets a verbal response or acknowledgment to agree with the terms of the contract. As another example, the parties sign their names or take another action (such as an action discussed in connection with block 130) indicating acceptance.

An example embodiment reviews or analyzes the terms of the contract to determine whether the contract includes consideration. Consideration represents value given by a promissor to a promisee in exchange for something of value given by the promissory to the promisee. For example, the value is money, an act, or forbearance of an act.

An example embodiment includes an information extractor that executes one or more of terminology mining, term extraction, term recognition, keyword recognition, glossary extraction, or another form of information extraction to extract and/or analyze terms in the contract to determine that the contract includes consideration, complies with legality, and/or has appropriate offer and acceptance.

Consider an example in which an information extractor analyzes the terms of the contract to determine that the contract is bilateral in which both parties provide one or more promises to each other. For instance, both parties are obligated to a provision of secrecy, privacy, or confidentiality with regard to personal information or acts of the other party.

Consider another example in which an information extractor analyzes the terms of the contract to determine that the contract includes adequacy or sufficiency of consideration. For example, one or more parties provide something of value, provide an act, or forebear from an act. For instance, both parties promise to keep an intimate encounter confidential. As another example, both parties agree not to publicly disclose personal information about a person (such as financial information about a person, sexual information about a person, or conversations with a person).

Consider another example in which an information extractor analyzes the terms of the contract to determine that the purpose of the contract is lawful. For example, terms or conditions of the contract require a person to perform an illegal act. As another example, the contract includes an illegal or inappropriate provision (such as a provision in which a person agrees to work for less than minimum wage or a provision for the solicitation of sexual services).

An example embodiment verifies capacity of the parties to enter into the contract. Capacity includes, but is not limited to, one or more of having an appropriate or legal age, having or not having a mental condition (such as being insane or having a mental deficiency to prevent entering into a contract), being under the influence of alcohol or drugs, being bankrupt or another physical or mental state that would affect the ability to enter into a legally binding agreement, having a disability that would affect an ability to enter into a contract, acting beyond your power (such as ultra vires).

Consider an example in which an example embodiment verifies a full name of each party and then executes one or more searches (such as database searches and/or search engine searches) to verify an age of each party. For instance, an age of each party is verified to be eighteen years or older (i.e., has an age of at least eighteen years).

Consider an example in which an electronic device captures an image of a person, and facial recognition assists in determining whether the person is under the influence of alcohol or drugs. For example, facial features of the person are digitally mapped and compared to baseline images of the person. For instance, a database stores images of the person when the person is known to be sober and/or known to be under the influence. A comparison of these images reveals whether the person is or possibly is under the influence of alcohol or a drug.

An example embodiment analyzes an image, video, and/or audio of a person to determine whether the person is under an influence of alcohol and/or drugs. By way of example, image and/or voice analysis looks for, recognizes, detects, or determines glassy eyes, dilated pupils, red eyes, watery eyes, frequent or continuous squinting, slow reflexes, slurred speech, slow movements or responses to questions, drooping eyelids, involuntary eye movement, sleepy or fatigued appearance, loss of balance, impaired coordination, odor, tremors, sweating, and other physical, emotional, or psychological warning signs.

Facial recognition can also be coupled with or used in conjunction with other methods and apparatus. For example, a GPS location of a person provides an indication or factor as to the capacity of the person (such as determining whether or how long the person was in a bar, club, or establishment that serves alcohol). As another example, an electronic device includes a built-in breathalyzer or communicates with a breathalyzer to determine or estimate blood alcohol content. As another example, an electronic device computes or estimates blood alcohol content of a person based on one of more factors, such as a gender of a person, rate or duration of consumption, body weight of the person, an amount of alcohol being consumed, and medications or drugs the person has taken.

An example embodiment determines and/or verifies an age of a person. By way of example, age determination and/or verification includes, but is not limited to, one or more of facial recognition, voice recognition, fingerprint recognition (or recognition of other biometric data), internet research, and database research. For instance, a name of a person is checked with a credit agency or one or more public records databases (such as a public database that includes records of legal proceedings, birth, marriage, death, address, education, etc.). Credit bureaus, commercial records, employment records, financial or tax records, and background checks are also available and searchable online (such as over the Internet). As another example, facial recognition software determines a gender, an age, and an identity of person. For instance, an image of a person is captured and provided to one or more facial recognition databases to determine whether the database has a match.

An example embodiment determines and/or verifies whether duress and undue influence exist. As one example, a determination is made as to whether one person has a position of power or authority over the other person. For instance, such a situation can occur if one person has a position of professional authority over another person (such as one person being an employee or boss of another person or one person being obligated under a contract with the other person). Additionally, the parties may have a special relationship (such as a doctor-patient relationship or an attorney-client relationship).

GPS locations can also be retrieved for each person for a specified period of time prior to consenting to the contract to determine a history of their locations. An identification and comparison of these locations can provide a factor or clue of duress, undue influence, emotion stress, or another factor that can prevent a person from entering a contract (such as providing an affirmative defense to the contract). For example, if one person was at a hospital, a prison, a cemetery, or a funeral, then this information can be a factor as to whether the person is under extreme stress.

Block 150 states store the contract.

An example embodiment securely stores the contract. For example, the contract is encrypted, stored at secure location (such as on a secure server, database, or cloud storage location), or stored on a secure portion of memory of an electronic device. For instance, a secure location on memory or protected memory is attained with segmentation (such as a specified memory segment), paging (such as paged virtual memory), protection keys (such as dividing memory into blocks with an associated protection key value), capability-based addressing (such as using protected objects or capabilities with privileged instructions executed with an authorized process), encryption, or another mechanism (such as hardware and/or software method to prevent reading or writing of information at a memory address of a computer or computer system). As another example, the contract file is set with a restriction (such as designating the file as read-only), set with a specific authorization access or permission (such as read permission, modify permission, ownership permission, or delete permission), designated to a private folder or memory location, set with a username and password access, or encrypted and transmitted to a cloud storage location.

Consider an example in which two consenting adults desire to establish or share an intimate sexual encounter. Before engaging in the intimate encounter, the two people want to ensure that the encounter is legal and voluntary and is not subject to duress, mistake, undue influence, fraud, or a factor that would jeopardize consent. Smartphones of the two people include a contract creator. This contract creator identifies the two people, validates the identities of the two people, retrieves personal information about the two people (such as an age, address, occupation, etc.), creates a dating contract between the two people, and displays the dating contract. The two people provide a thumbprint on displays of the smartphones to indicate consent, and the smartphones provide the signed contract to a secure cloud storage location that is accessible with the smartphones.

Consider an example in which users install or download a contract creator application to their handheld portable electronic devices (HPEDs). This application assists users in identifying and verifying other people and presents an agreement that two people trust each other and that each person will not disclose details about personal information (such as details about their dating history, their intimate or sexual encounters, financial records, assets and/or net worth, and other personal information). The agreement specifies one or more legal or civil penalties for violations of the terms of the agreement. By way of example, the contract creator captures biometric data of the people with a camera or other electronic device (such as an electronic scanner or reader). The image and/or biometric data are then used to determine and/or verify personal information about the people and to perform another service (such as displaying the gathered information to the people, creating a written agreement or contract, populating fields in a written agreement or contract, and/or providing a recommendation to the people based on the gathered information).

An example embodiment can provide a warning or recommendation as to whether a person should or should not engage in a contract or an encounter with another person. This recommendation or warning can be based on verification and/or validation information about a person.

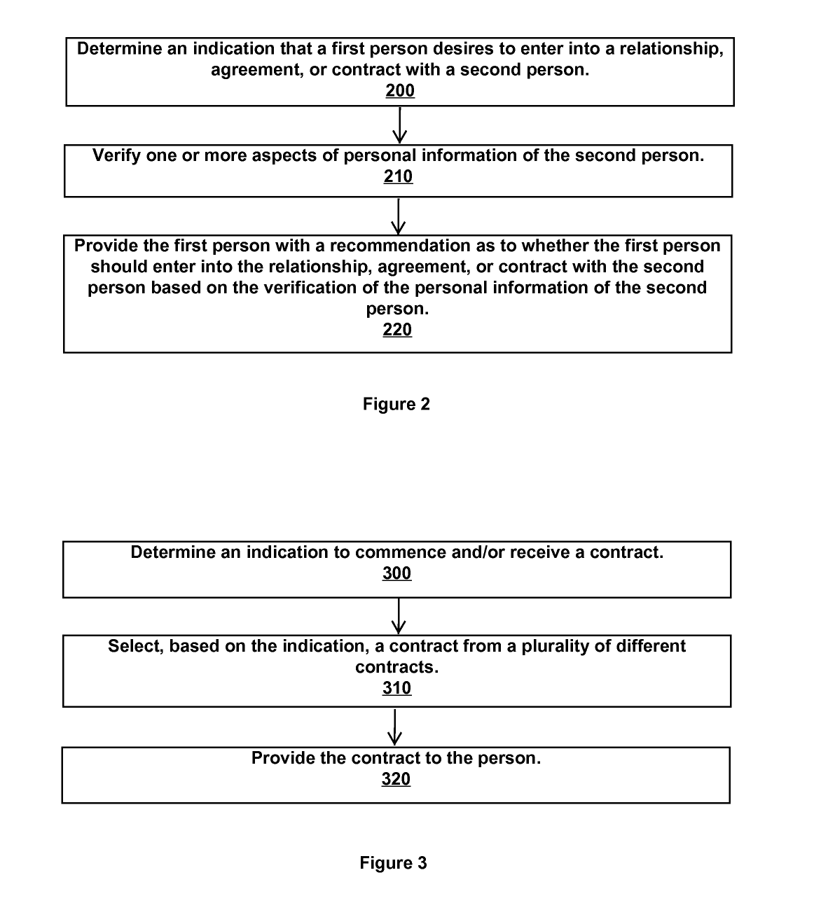

FIG. 2 is a method to provide a recommendation and/or warning to a person before the person enters into a contract with another person.

Block 200 states determine an indication that a first person desires to enter into a relationship, agreement, or contract with a second person.

By way of example, the first person communicates an indication or a desire for the first person to enter into a contract with the second person. For instance, the first person communicates a command or an instruction through a user interface to the electronic device. As another example, an electronic device determines the indication or the desire for a contract through one or more indications or factors. For instance, such indications or factors include, but are not limited to, a location of a person, an activity of a person, a time of day, a day of the week or month, an identity of a person, or a schedule or plan of a person.

Block 210 states verify one or more aspects of personal information of the second person.

By way of example, personal information includes, but is not limited to, academic diplomas, academic degrees, schools attended, training attended, certifications, security clearances, employment history, badges, name, previous and current addresses, publications, criminal records, marital status, civil lawsuits, licenses (such as operator licensing of automobiles, boats, and aircraft), credit history, blogs, family and personal history, biometrics (such as fingerprints, voice recognition, retinal scans), credentials (such as trade credentials or academic credentials), titles, memberships, birth certificate, military service, Internet search (such as searching a face, a name, or an address on a search engine), sex offender registry, and background checks.

Consider an example in which an identity determiner receives personal information about the second person and executes one or more Internet searches to verify whether the personal information is accurate or correct. For example, information provided by the second person is compared with information discovered about the second person, and this comparison reveals whether the second person provided truthful and complete personal information. The searches also discover or reveal new information not previously known or disclosed about the second person.

Block 220 states provide the first person with a recommendation as to whether the first person should enter into the relationship, agreement, or contract with the second person based on the verification of the personal information of the second person.

By way of example, an electronic device displays the recommendation, transmits the recommendation, processes the recommendation, stores the recommendation, or states the recommendation (such as providing an audible sound).

Consider an example in which a man and a woman meet through an online dating website or dating application. The man states that his name is John Smith and that he is from Houston, Texas and twenty-six years old. The woman states that her name is Jane Doe and that she is from San Diego, California and twenty-six years old. John and Jane decide to enter into a dating contract that specifies their willingness to date, to have intimate relations, and to maintain certain personal information confidential. Before entering into the contract, Jane takes a picture of John with her smartphone that includes a contract creator with an identity verifier or identity determiner. The identity verifier performs a background check on John that includes executing facial recognition software to match the picture of John with a database of images, executing public records database searches to verify a name, address, and age of John, and executing Internet-based searches via a search engine to gather personal information about John. Based on these searches, the identity verifier discovers the following about John Smith: John Smith is thirty-two years old, from New Orleans, Louisiana, and has a conviction of driving under the influence (DUI). Jane's smartphone displays this information and a warning that the information obtained about John Smith from the identity verifier does not match the information that John Smith provided to Jane and/or to the online dating website or dating application. Jane decides to end her relationship with John and not enter into a contract with him.

An example embodiment can create different types of contracts and recommend one or more these contracts to a person. By way of example, such contracts include bilateral contracts, unilateral contracts, executory contracts, and voidable contracts. Other example contracts include, but are not limited to, labor contracts, contracts for the sale of a good or service, dating contracts, employment contracts, rental agreements or lease contracts, loan or financial contracts, contracts including confidentiality or secrecy provisions, business contracts, and licensing agreements.

FIG. 3 is a method to recommend a contract to a person based on one or more factors.

Block 300 states determine an indication to commence and/or retrieve a contract.

By way of example, a person communicates an indication or a desire for an electronic device to retrieve a contract (such as a user communicating a command or an instruction through a user interface to the electronic device). As another example, an electronic device determines the indication or the desire for a contract through one or more indications or factors. For example, such indications or factors include, but are not limited to, a location of a person, an activity of a person, a time of day, a day of the week or month, an identity of a person, a schedule or plan of a person.

Block 310 states select, based on the indication, a contract from a plurality of different contracts.

An electronic device can select a contract for the person based on the indication. For example, the electronic device predicts which type of contract the person would like to have, retrieves this type of contract, modifies the contract, and presents it to the person. As another example, the electronic device displays a list or menu of different contracts, and the person selects the contract from this list.

Block 320 states provide the contract to the person.

For example, an electronic device displays the contract, transmits the contracts, stores the contract, processes the contract, or performs an action discussed herein.

Consider an example in which a woman goes to a bar on a weekend night and meets a man at the bar. The man and the woman decide to date and share an intimate encounter. Before having this encounter, they want a contract that acknowledges their desire and willingness to date and be intimate. The contract would also include confidentiality clauses to protect public dissemination of certain aspects of their relationship. Based on the location, time, date, and day, a handheld portable electronic device or HPED (such as a smartphone) of the woman automatically selects a dating contract with the appropriate clauses to protect her and his interest. The HPED of the woman communicates with an HPED of the man, gathers personal information of the man, completes a draft of a dating contract, and presents the draft dating contract to the man and to the woman. The man and the woman agree to the terms and conditions in the dating contract and sign it.

Consider an example in which a landlord owns an apartment building in which apartment units are leased to tenants. John is a tenant at the apartment building and lives in unit 3. Several days before John's annual lease will expire, the landlord goes to the apartment building. Based on a GPS location of the landlord at the apartment building and the fact that the lease for unit 3 will expire in a few days, the landlord's smartphone predicts a request for the lease for unit 3, automatically retrieves the lease, and updates the terms and conditions for a year extension. When the landlord arrives at unit 3, he provides a verbal instruction to the smartphone to retrieve the lease contract. The revised or new contract, however, is already completed since the smartphone predicted the request, and the revised lease is provided to the landlord and to the tenant.

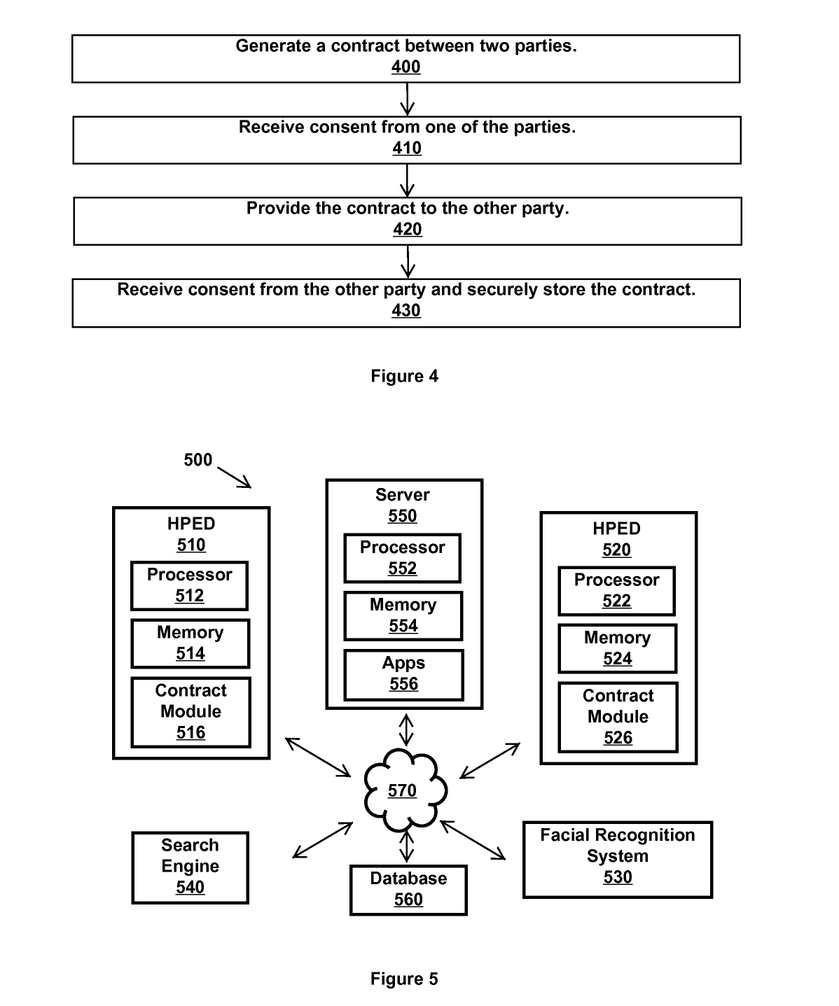

FIG. 4 is a method to securely exchange a contract between two or more electronic devices.

Block 400 states generate a contract between two parties.

In an example embodiment, contracts, agreements, documents, and other information or data can be securely retrieved, processed, generated, exchanged, transmitted, and stored (such as using one or more of encoding, cryptography, encryption). For example, a cipher uses a secret-key technique or a public-key technique. For instance, data exchange between two HPEDs uses symmetric cryptography in which the parties share a single key or uses asymmetric cryptography in which the parties exchange a pair of keys (a public key and a private key).

By way of example, the contract is generated, created, modified, or completed with a contract creator or method or device discussed herein.

Block 410 states receive consent from one of the parties.

In order to consent to a contract, a party can provide an actual written signature on the contract. Alternatively, the party can consent or agree to the contract with another action (such as providing a thumbprint, providing a digital signature, checking a box, providing verbal or oral consent, making a physical gesture to signify consent, providing consent via a method or technique discussed herein, providing recognizable consent in another manner).

An electronic device of the consenting party or another electronic device can generate the contract, assist in generating the contract, obtain the contract, or receive the contract (such as receiving the contract from a server via the Internet or another network).

Block 420 states provide the contract to the other party.

The contract can be directly provided to the other party (such as wirelessly transmitting the contract from a first HPED of a first person to a second HPED of a second person). Alternatively, the contract can be indirectly provided to the other party (such as the contract being provided to one or more people via a server or cloud). Further, the contract can be stored on the respective HPEDs and/or stored on a server or third party location (such as being stored on a central server).

Block 430 states receive consent from the other party and securely store the contract.

The contract is securely stored after both parties consent to the contract. For example, the contract is encrypted and stored on a secure server, cloud, or database.

In addition to storing the contract, other data concerning the contract can also be stored. Such other data includes, but is not limited to, metadata, personal information about the parties to the contract, photographs, images, and video of the parties to the contract, voice and sound recordings of the parties to the contract, GPS locations of the parties, time and date of consenting to the contract, and other information discussed herein.

Consider an example in which user A with HPED A and user B with HPED B desire to exchange a contract stored on HPED A. An application or barcode generator on HPED A generates a unique barcode image or Quick Response (QR) code that displays on a display of HPED A. A barcode reader on HPED B reads the barcode (e.g., captures a picture of the barcode image with a camera) and decodes the barcode to receive or retrieve the contract. For example, the barcode includes a website link, uniform resource locator (URL), or a public or private key that enables HPED B to retrieve and open the contract. User B consents to the contract and digitally signs it. HPED B encrypts the contract and sends it to a third-party server, web service, third-party storage location, network location, or host. Submission of the contract includes deal metadata, such as information that identifies the time, date, geographical location of HPED A, geographical location of HPED B, user A, and user B. For example, the contract and the metadata are stored in an online database for archival and later retrieval.

In an example embodiment, electronic devices (such as HPEDs) execute near-field-communication (NFC) technology to detect the presence of another electronic device and capture, transmit, or receive the contract from the electronic device.

In an example embodiment, one or more methods, blocks, modules, or applications are installed on an HPED over-the-top (OTT) as an application or used as a mobile web application (such as being used in or with a web browser of an HPED).

Consider an example in which HPED A of user A includes a client application, and HPED B of user B includes a basic application that communicates with the client application to execute an example embodiment. The basic application includes a barcode reader that reads barcodes generated by the client application and that collects a signature of user B and other information (such as a timestamp when the contract is signed, a geographical location of the HPEDs and users, carrier details, and personal information). The client application displays a library of different pre-written partial or complete contracts (or agreements) and enables user A to select one of these contracts. After one of the contracts are selected or accepted, the client application prepares the contract, receives or obtains a digital signature of user A, and provides this signature to the contract. A camera in HPED A captures an image or photograph of user B, and the client application generates and displays a unique barcode on a display of HPED A. A camera in HPED B scans the barcode or captures an image of the barcode, and the basic application displays an image of the contract on a display of HPED B. The basic application receives or obtains a digital signature of user B, provides this signature to the contract, and transmits the signed contract, photograph of user B, and other data (such as metadata or other data discussed herein) to a web server.

FIG. 5 is a computer system 500 that includes a first HPED 510 (shown with processor 512, memory 514, and contract module 516), a second HPED 520 (shown with processor 522, memory 524, and contract module 526), facial recognition system 530, a search engine 540 (such as a web-based search engine), one or more servers 550 (shown with processor 552, memory 554, and software applications 556), and a database or storage 560 in communication through one or more networks 570.

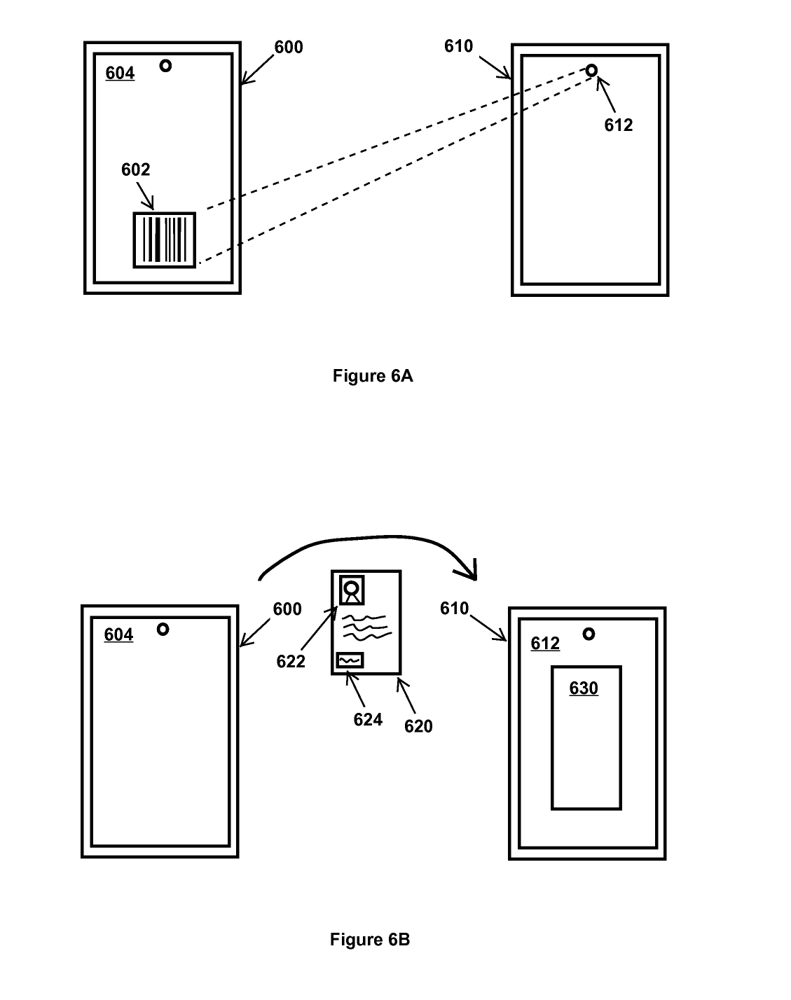

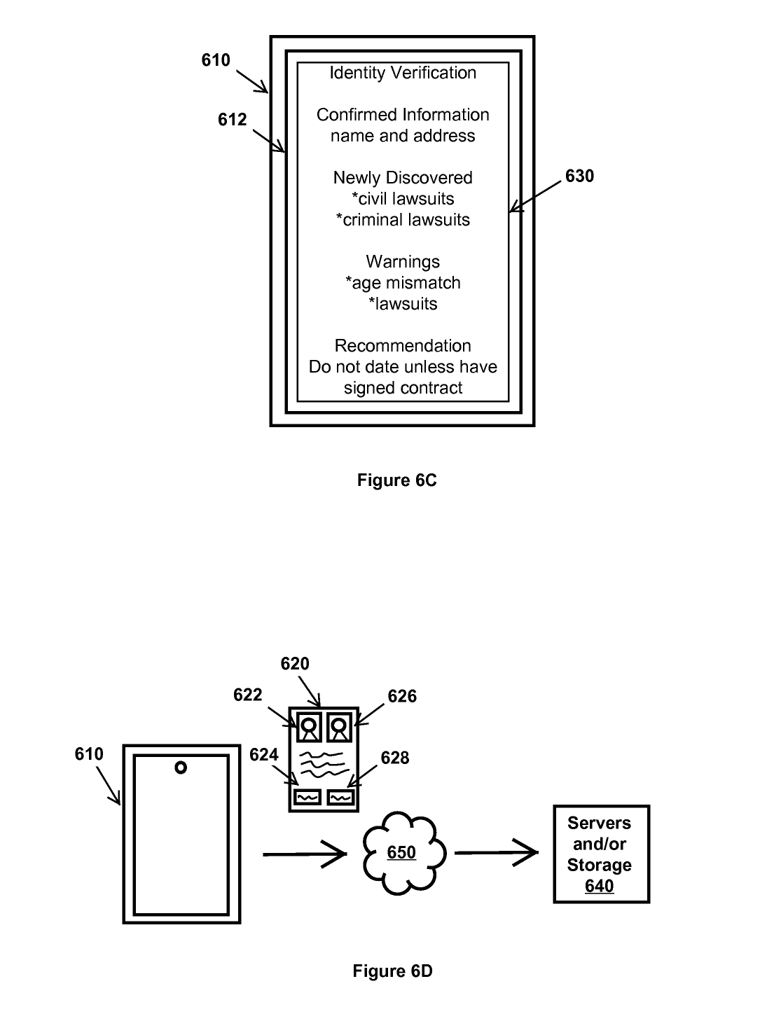

FIGS. 6A-6D shown electronic devices communicating with each other to create, exchange, and store a contract.

In FIG. 6A, a first HPED 600 generates and displays a barcode 602 on its display 604. The barcode includes information relating to a contract (such as a contract stored on the HPED 600 or stored on a server or database in communication with the HPED 600). A second HPED 610 includes a barcode reader 612 that reads the barcode and the information relating to the contract. By way of example, this information can include information contained in the contract, access to the contract, personal information, or other information discussed herein.

In FIG. 6B, HPED 600 wirelessly transmits a contract 620 to the HPED 610. By way of example, the contract 620 includes a picture or image 622 of a party to the contract (such as a user of HPED 600) and consent 624 of the party to the contract (such as a signature or other acknowledgement of acceptance of the terms of the contract).

The HPED 610 (and/or an electronic device in communication with the HPED 610) verifies one or more aspects of the contract, such as personal information of the parties, terms and conditions in the contract, legal elements of contract formation, or blocks or methods discussed herein. A display 612 of the HPED 610 displays verification 630 of some of this information.

FIG. 6C shows an example of this verification 630 (shown as “Identity Verification”) includes personal information that is confirmed or verified to be true and/or accurate (shown as “Confirmed Information” with name and address), personal information or other information that is newly discovered (shown as “Newly Discovered” information with civil lawsuits and criminal lawsuits), warnings about inaccuracies or false information (shown as “Warnings” with an age mismatch and lawsuits), and recommendation on how to proceed (shown as “Recommendation” with do not date unless have signed contract).

In FIG. 6D, HPED 610 encrypts the contract 620 and wirelessly sends it to a server and/or storage 640 via one or more networks 650. The contract 620 includes the picture 622 and consent 624 of one party to the contract and a picture 626 and consent 628 of the other party to the contract.

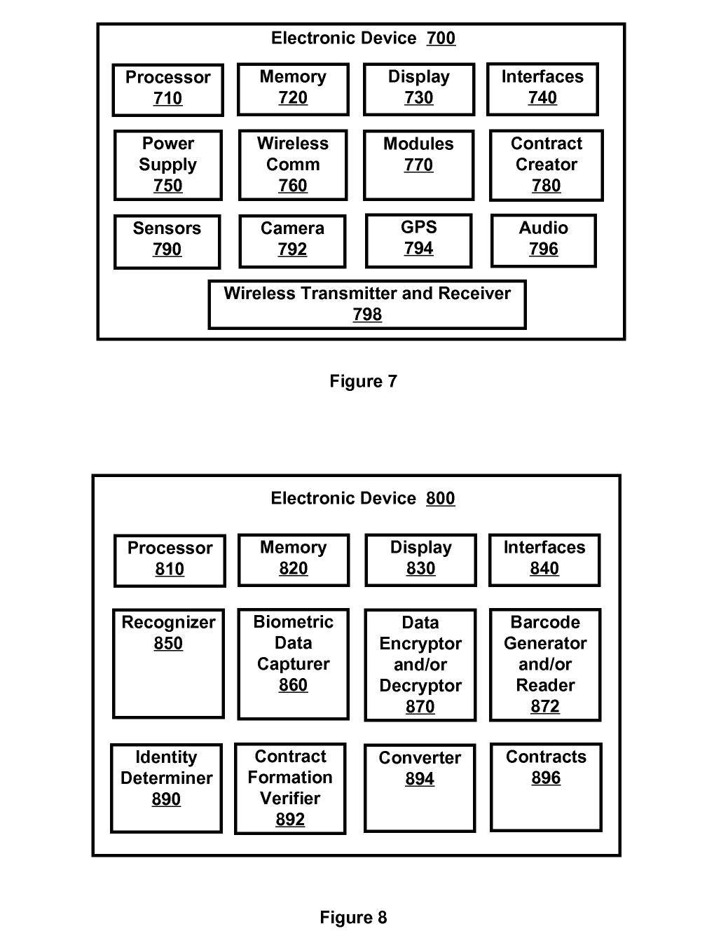

FIG. 7 is an electronic device 700 that includes one or more of the following: a processing unit or processor 710, a computer readable medium (CRM) or memory 720 (such as a memory storing one or more blocks discussed herein), a display 730, one or more interfaces 740 (such as a network interface, a graphical user interface, a natural language user interface, and/or an interface that combines reality and virtuality), a battery or a power supply 750, wireless communication 760, one or more modules 770 (for example to execute one or more methods blocks described herein), a contract converter or contract creator 780, one or more sensors 790 (such as a biometric sensor), one or more cameras 792, a Global Positioning System 794, audio 796 (such as a speaker and/or microphone), and a wireless transmitter and receiver 798.

FIG. 8 is an electronic device 800 that includes one or more of the following: a processing unit or processor 810, a computer readable medium (CRM) or memory 820, a display 830, one or more interfaces 840 (such as a network interface, a graphical user interface, a natural language user interface, and/or an interface that combines reality and virtuality), one or more recognizers 850 (such as facial recognition software), a biometric data capturer 860, a data encryptor and/or decryptor 870 (such as hardware and/or software to encrypt and decrypt data), a barcode generator and/or reader 880, an identity determiner 890 (such as discussed in block 100 and including for example an identity capturer and an identity validater), a contract formation verifier 892 (such as discussed in block 140), a converter 894 (such as a speech to text converter and a text to speech converter), and contracts 896 (such as different types of agreements, contracts, templates, and other documents discussed herein).

FIGS. 7 and 8 show various components in a single electronic device. One or more of these components can be distributed or included in various electronic devices, such as some components being included in an HPED, some components being included in a server, some components being included in storage accessible over the Internet, some components being in wearable electronic devices, and some components being in various different electronic devices that are spread across a network, a cloud, and/or an electronic device system or a computer system.

The processing unit or processor (such as a central processing unit, CPU, microprocessor, application-specific integrated circuit (ASIC), etc.) controls the overall operation of memory (such as random access memory (RAM) for temporary data storage, read only memory (ROM) for permanent data storage, and firmware). The processing unit or processor communicates with memory and performs operations and tasks that implement one or more blocks of the flow diagrams discussed herein. The memory, for example, stores applications, data, programs, algorithms (including software to implement or assist in implementing example embodiments) and other data.

Blocks and/or methods discussed herein can be executed and/or made by a user, a user agent of a user, a software application, hardware, an electronic device, a computer, and/or a computer system.

Examples of an electronic device include, but are not limited to, a server, a computer, a laptop computer, a tablet computer, a handheld portable electronic device (HPED), a portable electronic device (PED), a wearable electronic device (WED), wearable electronic glasses (WEG), a smartphone, a camera, a non-portable electronic device, a portable electronic device, and an electronic device with a processor, a memory, and a display.

One or more modules, capturers, validaters, verifiers, and/or determiners can be located on an electronic device (such as an HPED) or in a server (such as a cloud server). For example, one or more these are located on a server to reduce a cost, weight, and/or size of an HPED. Further, these can be included as part of a software application or program and distributed to different electronic devices.

As used herein, a “dating contract” is a contract or an agreement between two adults that have or will have an intimate relationship that involves physical intimacy and/or emotional intimacy. Physical intimacy is characterized by romantic or passionate attachment or sexual activity.

As used herein, “determine” includes to ascertain, to analyze, to evaluate, to process, to calculate, to decide, to obtain, to discover, to retrieve, to execute, and/or to receive.

As used herein, a “module” is software (such as part of a software program) and/or hardware (such as a self-contained component, separate component, or component on a circuit board or with other components). A module can represent one or more blocks discussed herein.

In some example embodiments, the methods illustrated herein and data and instructions associated therewith are stored in respective storage devices, which are implemented as computer-readable and/or machine-readable storage media, physical or tangible media, and/or non-transitory storage media. These storage media include different forms of memory including semiconductor memory devices such as DRAM, or SRAM, Erasable and Programmable Read-Only Memories (EPROMs), Electrically Erasable and Programmable Read-Only Memories (EEPROMs) and flash memories; magnetic disks such as fixed, floppy and removable disks; other magnetic media including tape; optical media such as Compact Disks (CDs) or Digital Versatile Disks (DVDs). Note that the instructions of the software discussed above can be provided on computer-readable or machine-readable storage medium, or alternatively, can be provided on multiple computer-readable or machine-readable storage media distributed in a large system having possibly plural nodes. Such computer-readable or machine-readable medium or media is (are) considered to be part of an article (or article of manufacture). An article or article of manufacture can refer to any manufactured single component or multiple components.

Method blocks discussed herein can be automated and executed by a computer, computer system, user agent, and/or electronic device. The term “automated” means controlled operation of an apparatus, system, and/or process using computers and/or mechanical/electrical devices without the necessity of human intervention, observation, effort, and/or decision.

The methods in accordance with example embodiments are provided as examples, and examples from one method should not be construed to limit examples from another method. Further, methods discussed within different figures can be added to or exchanged with methods in other figures. Further yet, specific numerical data values (such as specific quantities, numbers, categories, etc.) or other specific information should be interpreted as illustrative for discussing example embodiments. Such specific information is not provided to limit example embodiments.

What is claimed is:

1. A method executed by a computer system to generate a dating contract for an intimate relationship between two adults, comprising:
capturing, with one or more cameras in the computer system, an image of each of the two adults;
verifying, by the computer system and based on the image of each of the two adults, a given name and a surname of each of the two adults;
generating, by the computer system, the dating contract for the intimate relationship between the two adults;
receiving, via one or more handheld portable electronic devices (HPEDs) in the computer system, consent from each of the two adults to enter into the dating contract;
verifying, with the computer system, that each of the two adults have a legal element of capacity to enter into the dating contract; and
storing the dating contract in the computer system.

2. The method of claim 1 further comprising:
verifying, with the computer system, the capacity by comparing facial features from the image of each of the two adults with baseline images of the two adults to determine whether the two adults are under an influence of alcohol or drugs.

3. The method of claim 1 further comprising:
verifying, with the computer system, the given name and the surname of each of the two adults by providing the image of each of the two adults to a facial recognition system that verifies a full name of each of the two adults.

4. The method of claim 1 further comprising:
receiving a thumbprint from each of the two adults;
verifying, with the computer system and based on the thumbprint from each of the two adults, an identity of each of the two adults.

5. The method of claim 1 further comprising:
analyzing, by the computer system, terms in the dating contract to determine whether the dating contract requires one of the two adults to perform an illegal act.

6. The method of claim 1 further comprising:
verifying, by the computer system, that each of the two adults has an age of at least eighteen years.

7. The method of claim 1 further comprising:
capturing, with the computer system, a Global Positioning System (GPS) location of the two adults when the consent to enter into the dating contract;
storing, with the computer system, the GPS location with the dating contract.

8. The method of claim 1 further comprising:
verifying, with the computer system, whether one of the two adults has a position of professional authority over another of the two adults.

9. A handheld portable electronic device (HPED) that creates a dating contract between a first person and a second person, the HPED comprising:
a processor;
a memory that communicates with the processor;
a camera that takes a photograph of a second person;
an identity determiner that is stored in the memory and that wirelessly communicates with an internet to determine, based on an analysis of the photograph, a name and an address of the second person;
contract creator that is stored in the memory and that creates the dating contract between the first person and the second person;
a display that displays the dating contract; and
a wireless transmitter that wirelessly transmits the dating contract over the internet to secure storage after the dating contract receives consent from both the first person and the second person.

10. The HPED of claim 9 further comprising:
a biometric data capturer that captures a fingerprint of the second person, transmits the fingerprint over the internet to fingerprint database, and verifies an identity of the person based on results from analysis of the fingerprint with the fingerprint database.

11. The HPED of claim 9, wherein the identity determiner displays a warning on the display when the name and the address of the second person do not match a name and an address provided by the second person.

12. The HPED of claim 9 further comprising:
a barcode generator that generates a unique barcode that includes information about the dating contract.

13. The HPED of claim 9 further comprising:
a facial recognizer that analyze that transmits the photograph over the internet to facial recognition database, and verifies an identity of the person based on results from analysis of the photograph with the facial recognition database.

14. The HPED of claim 9, wherein the contract creator creates the dating contract to include a photograph of the first person and the photograph of the second person.

15. The HPED of claim 9 wherein the contract creator captures a timestamp of when the first person consents to the dating contract, a timestamp of when the second person consents to the dating contract, a Global Positioning System (GPS) location of the first person when the first person consents to the dating contract, and a GPS location of the second person when the second person consents to the dating contract.

16. A non-transitory computer readable storage medium storing instructions that cause one or more processors to execute a method, comprising:
obtain, with a handheld portable electronic device (HPED), an image of a first person and an image of a second person that desire to enter into a dating contract;
execute facial recognition on the image of the first person and on the image of the second person to verify full names of the first person and the second person;
generate, with a contract creator application, the dating contract between the first person and the second person;
receive, via the HPED, consent from the first person and the second person to enter into the dating contract; and
transmit the dating contract to a secure storage location.

17. The non-transitory computer readable storage medium of claim 16 storing instructions that cause the one or more processors to execute the method, further comprising:
analyze the image of the first person and the image of the second person to determine whether the first person and the second person are under an influence of alcohol.

18. The non-transitory computer readable storage medium of claim 16 storing instructions that cause the one or more processors to execute the method, further comprising:
communicate with a web-based search engine to verify that the first person and the second person have an age of at least eighteen years.

19. The non-transitory computer readable storage medium of claim 16 storing instructions that cause the one or more processors to execute the method, further comprising:
generate, with the HPED, a barcode that identifies the dating contract; and
display, with the HPED, the barcode so a barcode reader on another HPED can read the barcode and obtain the dating contract.

20. The non-transitory computer readable storage medium of claim 16 storing instructions that cause the one or more processors to execute the method, further comprising:
obtain, via a natural user interface on the HPED, personal information from the first person and the second person; and
insert the personal information from the first person and the second person into the dating contract.
